(19) United States
(12) Patent Application Publication
(10) Pub. No.: US 2014/0184526 A1
(43) Pub. Date: Jul. 3, 2014

(54) METHOD AND APPARATUS FOR DUAL DISPLAY

(71) Applicant: LG ELECTRONICS INC., Seoul (KR)

(72) Inventor: Eunhyung CHO, Seoul (KR)

(73) Assignee: LG ELECTRONICS INC., Seoul (KR)

(21) Appl. No.: 13/779,216

(22) Filed: Feb. 27, 2013

(30) Foreign Application Priority Data
Dec. 31, 2012 (KR) 10-2012-0158321

(51) Int. Cl. G06F 3/041

(52) U.S. Cl. CPC G06F 3/041
USPC 345/173

(57) ABSTRACT

Disclosed is a dual display apparatus to display first and second display screens. The dual display apparatus includes a display unit to display the first and second display screens, and an input unit to receive a first or second multi-touch gesture signal. The first multi-touch gesture signal includes pinch-in signals to expand content displayed in the first display screen, and the second multi-touch gesture signal includes a sliding touch to expand the first display screen or to change the first display screen to the entire display screen. The dual display apparatus further includes a screen adjustment module to expand content displayed in the first display screen in response to the first multi-touch gesture signal, and to display the expanded first display screen or the changed entire display screen in response to the second multi-touch gesture signal. The first and second multi-touch gesture signals are input in succession via a touch.

This application claims the benefit of Korean Patent Application No. 10-2012-0158321, filed on Dec. 31, 2012, which is hereby incorporated by reference as if fully set forth herein.

### BACKGROUND OF THE INVENTION

1. Field of the Invention

The present disclosure relates to a method and apparatus to enable adjustment of the size of a dual display screen including a touchscreen, and more particularly to a method and apparatus, which realize not only expansion in the size of one of dual display screens to the entire screen, but also screen change from one of dual display screens to the entire screen, in response to a multi-touch gesture signal input by a user without requiring an additional screen change function.

2. Discussion of the Related Art

A touchscreen refers to a display screen equipped with a specific input device to receive a position touched by a user. The touchscreen may include both a content display area and a user touch input unit. With advances in touchscreen technology, in display devices including cellular phones, tablet PCs, digital TVs, etc., importance of a user-friendly user interface using a touchscreen is rapidly increasing. This serves to maximize user convenience other than merely changing a product design, and causes developments of various applications based on convenience of touchscreen input. In particular, a multi-touch technique as one of these application techniques is coming into the spotlight to maximize user convenience and utility. The multi-touch technique is a technique that realizes recognition of a multi-touch gesture signal that a user inputs via a touchscreen or a touch pad, i.e. multiple touch points input at the same time. This enables more diverse operations than recognition of only one touch point via a mouse, etc. In particular, although conventional touch techniques have only a limited function to merely input change in position via a touch, the multi-touch technique can designate a response of an apparatus to a touch based on the number of sensed touch points and can even allow adjustment depending on change in a distance between touch points. Accordingly, the multi-touch technique has an advantage of facilitating signal processing and operations in response to user intention.

Moreover, with advances in touchscreen technology, a dual screen or dual display system in which two or more screens are displayed in a single display apparatus is a focus of attention in view of maximization of user convenience. This is because the dual display system can advantageously maximize user convenience by providing a single display apparatus having a physically limited size with a plurality of display screens capable of displaying a plurality of content, differently from a multi-screen system that provides a user with a plurality of display screens using a plurality of display devices. In particular, this technique is of great interest in the field of mobile terminals, which are widely used in recent years.

### SUMMARY OF THE INVENTION

Owing to combination of the multi-touch technique with the dual display system technique as described above, it becomes possible for a user to selectively input a multi-touch gesture signal to two or more display screens displayed at the same time in a single display apparatus, so as to perform an independent operation on each display screen.

However, in a conventional dual display system, although it is permitted for the user to expand the size of one display screen among dual display screens using a multi-touch gesture signal, further expanding the size of the expanded display screen to the size of the entire display screen requires an additional function to change one display screen to the entire display screen. That is, the multi-touch gesture signal for expansion in the size of one screen and the screen change function to change one display screen to the entire display screen must be independently carried out, which results in a reduction in user convenience.

Accordingly, the present disclosure is directed to a method and apparatus for dual display that substantially obviate one or more problems due to limitations and disadvantages of the related art.

Other advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, there are provided a dual display method and a dual display apparatus in which, in a dual display system including a first display screen and a second display screen, the size of content displayed in the first display screen is expanded using a first multi-touch gesture, and the size of the first display screen is expanded or the first display screen is expanded to the entire display screen using a second multi-touch gesture.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram illustrating a dual display apparatus according to an embodiment of the present disclosure;

FIG. 2 is a view illustrating a display unit for dual display according to an embodiment of the present disclosure;

FIG. 3 is a view illustrating expansion or reduction in the size of content shown on a dual display screen in response to a multi-touch gesture signal according to an embodiment of the present disclosure;

FIG. 4 is a view illustrating expansion in the size of a first display screen or change from the first display screen to the entire display screen in response to a multi-touch gesture signal for expansion or screen change according to an embodiment of the present disclosure;

FIG. 5 is a view illustrating expansion in the size of a first display screen or change from the first display screen to the entire display screen using an indicator according to an embodiment of the present disclosure;

FIG. 6 is a view illustrating rotation of a first display screen in response to a multi-touch gesture signal for rotation according to an embodiment of the present disclosure;

FIG. 7 is a view illustrating reduction in the size of the entire display screen in response to a multi-touch gesture signal for reduction according to an embodiment of the present disclosure;

FIG. 8 is a view illustrating reduction in the size of the entire display screen in response to a multi-touch gesture signal for reduction according to another embodiment of the present disclosure;

FIG. 9 is a view illustrating reduction in the size of the entire display screen in response to a multi-touch gesture signal for reduction according to another embodiment of the present disclosure;

FIG. 10 is a view illustrating reduction in the size of the entire display screen in response to a multi-touch gesture signal for reduction according to a further embodiment of the present disclosure;

FIG. 11 is a view illustrating expansion in the size of a first display screen or change from the first display screen to the entire display screen in response to a multi-touch gesture signal for expansion or screen change according to another embodiment of the present disclosure; and

FIG. 12 is a flowchart of a dual display method according to an embodiment of the present disclosure.

### DETAILED DESCRIPTION OF THE INVENTION

Although the terms used in the following description are selected, as much as possible, from general terms that are widely used at present while taking into consideration the functions obtained in accordance with the present disclosure, these terms may be replaced by other terms based on intensions of those skilled in the art, customs, emergence of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

With advances in touchscreen technology, in display devices including cellular phones, tablet PCs, digital TVs, etc., importance of a user-friendly user interface using a touchscreen is rapidly increasing. This serves to maximize user convenience other than merely changing a product design, and causes developments of various applications based on convenience of touchscreen input. In particular, a multi-touch technique as one of these application techniques is coming into the spotlight to maximize user convenience and utility. The multi-touch technique is a technique that realizes recognition of a multi-touch gesture signal that a user inputs via a touchscreen or a touch pad, i.e. multiple touch points input at the same time. This enables more diverse operations than recognition of only one touch point via a mouse, etc. In particular, although conventional touch techniques have only a limited function to merely input change in position via a touch, the multi-touch technique can designate a response of an apparatus to a touch based on the number of sensed touch points and can even allow adjustment depending on change in a distance between touch points. Accordingly, the multi-touch technique has an advantage of facilitating signal processing and operations in response to user intention.

Moreover, with advances in touchscreen technology, a dual screen or dual display system in which two or more screens are displayed in a single display apparatus is a focus of attention in view of maximization of user convenience. Conventionally, to provide a user with a plurality of display screens to enable implementation of various operations, a plurality of display devices must be used. However, with advances in mobile appliances such as cellular phones, even a single display apparatus is designed to provide a plurality of display screens to achieve user convenience that allows the user to simultaneously perform a plurality of operations.

Owing to combination of the multi-touch technique with the dual display system technique as described above, it becomes possible for the user to selectively input a multi-touch gesture signal to two or more display screens displayed at the same time in the single display apparatus, so as to perform an independent operation on each display screen.

However, in a conventional dual display system, although it is permitted for the user to expand the size of one display screen among dual display screens using a multi-touch gesture signal, further expanding the size of the expanded display screen to the size of the entire display screen requires an additional function to change one display screen to the entire display screen. That is, the multi-touch gesture signal for expansion in the size of one screen and the screen change function to change one display screen to the entire display screen must be independently carried out, which results in a reduction in user convenience.

Hereinafter, a method and apparatus for dual display in which the size of content displayed in one display screen of dual display screens is selectively expanded and the size of the corresponding display screen is expanded to the size of the entire display screen in response to user multi-touch gesture will be described.

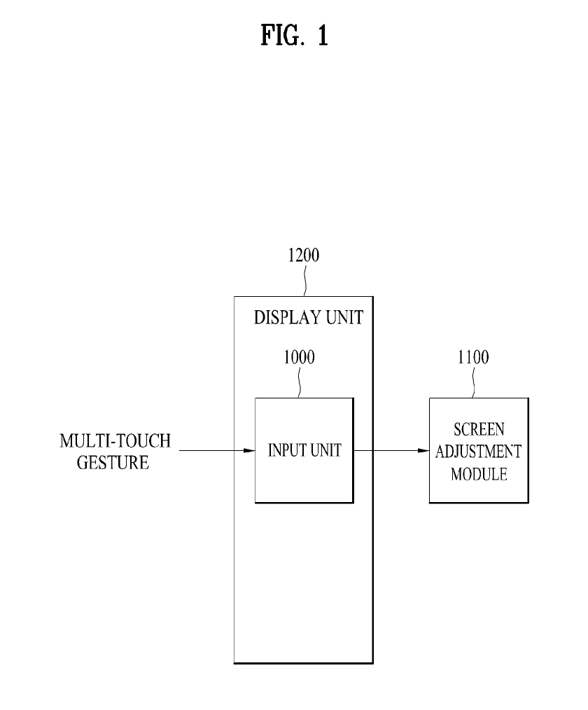

FIG. 1 is a block diagram illustrating a dual display apparatus according to an embodiment of the present disclosure.

The dual display apparatus according to the embodiment of the present disclosure may include an input unit 1000, a screen adjustment module 1100, and a display unit 1200.

The display unit 1200 according to the embodiment of the present disclosure includes a touchscreen. The display unit 1200 may consist of a display area and the input unit 1000. The display area according to the embodiment of the present disclosure may be called a display, and may be altered according to the intention of a designer. In addition, the display area included in the display unit 1200 according to the embodiment of the present disclosure may include a first display screen and a second display screen for dual display. The first display screen and the second display screen may be distinguishable from each other by an imaginary boundary line, and may have independent display areas. A detailed description thereof will follow.

The input unit 1000 serves to receive a multi-touch gesture signal and may be included in the display unit 1200. In this case, the input unit 1000 may be included independently of the display area, or may be distributed within the display area. This may be altered according to the intention of a designer.

The screen adjustment module 1100 serves to sense and analyze the input multi-tough gesture signal. The screen adjustment module 1100 may adjust or control the size of content displayed on the display unit 1200 or the size of each display screen included in the display unit 1200 in response to the multi-touch gesture signal.

In the context of the present disclosure, the multi-touch gesture signal refers to various multi-touch signals that can be input in order to adjust the size of content displayed in the first display screen and the size of content displayed in the second display screen, or to adjust the size of the first display screen and the size of the second display screen.

In the context of the present disclosure, content refers to all objects that can be managed and displayed by the dual display apparatus, and may include all of photographs, moving images, letters, applications, menu icons, etc. In addition, the screen adjustment module 1100 according to the embodiment of the present disclosure may serve to measure a touch contact time with respect to a surface of the display unit 1200 that constitutes the multi-touch gesture signal, or the number of touches input by the multi-touch gesture signal. A detailed description related to adjustment of the size of content or of the display screen in response to the multi-touch gesture signal will follow.

The display unit 1200 according to the embodiment of the present disclosure may serve to display content or the display screen adjusted and controlled by the screen adjustment module 1100.

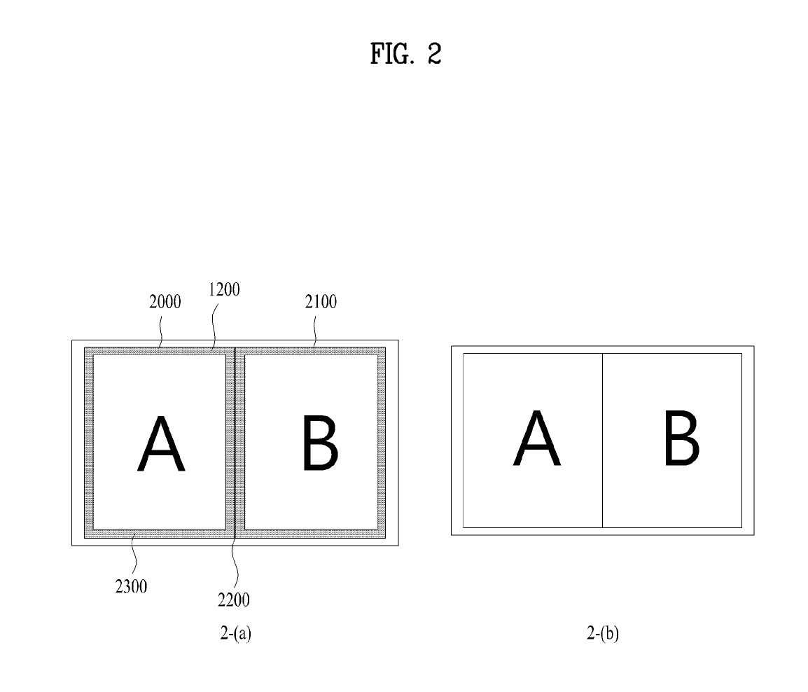

FIG. 2 is a view illustrating the display unit for dual display according to an embodiment of the present disclosure.

The display unit 1200 for dual display according to the embodiment of the present disclosure may include a first display screen 2000 and a second display screen 2100. The first display screen 2000 and the second display screen 2100 refer to independent display areas separated from each other by an imaginary boundary line 2200. Each display screen may display content within the independent display area. In addition, each display screen may receive a multi-touch gesture signal, and display content that is managed and adjusted independently in response to the input multi-touch gesture signal. In the embodiment of the present disclosure, the entire display screen refers to a display area having the same size as that of the display unit 1200, and may mean the display unit 1200 itself. Additionally, the size of the entire display screen is equal to the sum of the size of the first display screen 2000 and the size of the second display screen 2100.

As illustrated in FIG. 2, the first display screen 2000 and the second display screen 2100 may independently display respective content of the same category but having different details, and may display respective content differing in terms of both category and details. Hereinafter, for convenience, the case in which individual content displayed in the first display screen 2000 and the second display screen 2100 are English letters A and B respectively.

The first display screen 2000 and the second display screen 2100 may be separated from each other by the imaginary boundary line 2200. The first display screen 2000 and the second display screen 2100 separated from each other by the imaginary boundary line 2200 refer to independent display areas having the same size.

The imaginary boundary line 2200 may be represented in the form of a line such as a solid line, a dotted line, etc., in the form of a boundary between content displayed in the first display screen 2000 and content displayed in the second display screen 2100, or in the form of a predetermined-sized area. The means to separate the first display screen 2000 and the second display screen 2100 from each other may be referred to by other names than ‘boundary line’ according to the intention of a designer.

FIG. 2-(a) illustrates the display unit 1200 according to an embodiment of the present disclosure. Here, each of the first display screen 2000 and the second display screen 2100 includes a colored display frame 2300 therein. The colored display frame 2300 may not function to display content, and the shape and size thereof may be altered according to the intention of a designer.

FIG. 2-(b) illustrates the display unit 1200 according to an embodiment of the present disclosure. Here, each of the first display screen 2000 and the second display screen 2100 do not include the colored display frame 2300 therein. This may be altered according to the intention of a designer.

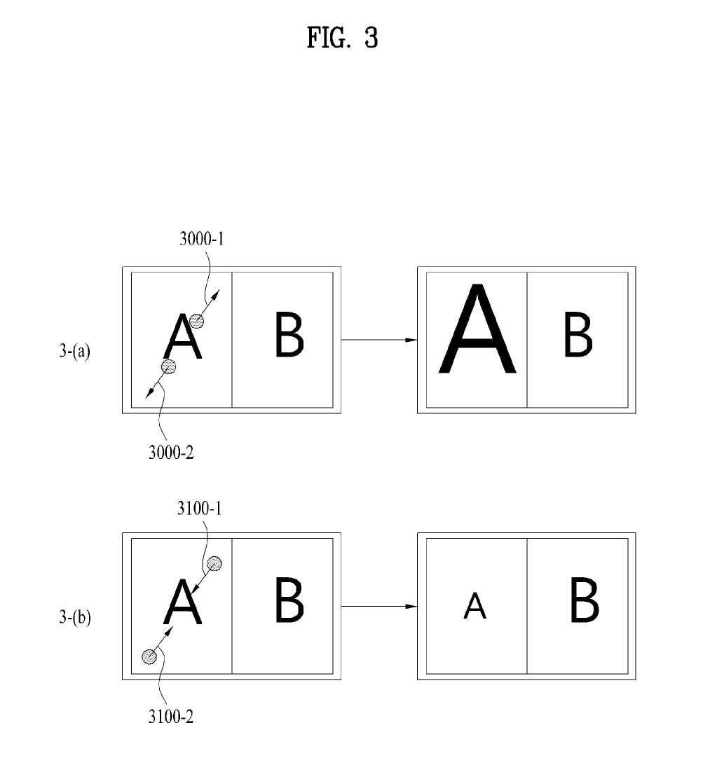

FIG. 3 is a view illustrating expansion or reduction in the size of content shown in the dual display screen in response to a multi-touch gesture signal according to an embodiment of the present disclosure.

In the embodiment of the present disclosure, a user can input a multi-touch gesture signal to the input unit 1000 in order to expand or reduce the size of content shown in the first display screen 2000 and the size of content shown in the second display screen 2100. As described above, the first display screen 2000 and the second display screen 2100 are separated from each other by an imaginary boundary line and have independent display areas. The first display screen 2000 and the second display screen 2100 may be managed and adjusted independently in response to the multi-touch gesture signal input to the independent display areas.

FIG. 3 is a view illustrating expansion or reduction in the size of content shown only in the first display screen 2000 described above in FIG. 2 in response to a multi-touch gesture signal according to an embodiment of the present disclosure. In FIG. 3, the multi-touch gesture signal is input via two touches. The two touches may be simultaneously input only to the first display screen 2000, or only one touch of the simultaneously input two touches may be input to the second display screen 2100 by passing over the imaginary boundary line.

More specifically, FIG. 3-(a) illustrates the case in which a multi-touch gesture signal according to an embodiment of the present disclosure includes so-called pinch-in signals 3000-1 and 3000-2, which enable expansion of the size of content displayed in the first display screen 2000.

In the embodiment of the present disclosure, the pinch-in signals 3000-1 and 3000-2 correspond to a multi-touch gesture signal generated as two input touches are continuously moved outward respectively, which may cause expansion in the size of displayed content based on the movement distances of the two touches.

As illustrated in the left side of FIG. 3-(a), if the pinch-in signals 3000-1 and 3000-2 are input with respect to content displayed in the first display screen, only the size of content displayed in the first display screen is expanded as illustrated in the right side of the same drawing.

As illustrated in FIG. 3-(a), the pinch-in signals 3000-1 and 3000-2 include a first touch 3000-1 and a second touch 3000-2. The first touch 3000-1 and the second touch 3000-2 are simultaneously input. Additionally, the screen adjustment module 1200 described with reference to FIG. 2 may sense the first touch 3000-1 and the second touch 3000-2, thereby determining the movement direction and distance of each touch and determining whether or not the currently input multi-touch gesture signal includes pinch-in signals. The screen adjustment module 1200 may further function to expand the size of content displayed in the first display screen based on the movement distances of the first touch 3000-1 and the second touch 3000-2.

FIG. 3-(b) illustrates the case in which a multi-touch gesture signal according to an embodiment of the present disclosure includes so-called pinch-out signals 3100-1 and 3100-2, which enable reduction of the size of content displayed in the first display screen 2000.

In the embodiment of the present disclosure, the pinch-out signals 3100-1 and 3100-2 correspond to a multi-touch gesture signal generated as two input touches are continuously moved inward respectively on the contrary to the pinch-in signals 3000-1 and 3000-2, which may cause reduction of the size of displayed content based on the movement distances of the two touches. As illustrated in the left side of FIG. 3-(b), if the pinch-out signals 3100-1 and 3100-2 are input with respect to content displayed in the first display screen, only the size of content displayed in the first display screen is reduced as illustrated in the right side of the same drawing.

As illustrated in FIG. 3-(b), the pinch-out signals 3100-1 and 3100-2 include a first touch 3100-1 and a second touch 3100-2. The first touch 3100-1 and the second touch 3100-2 are simultaneously input. Additionally, the screen adjustment module 1200 according to the embodiment of the present disclosure may sense the first touch 3100-1 and the second touch 3100-2, thereby determining the movement direction and distance of each touch and determining whether or not the currently input multi-touch gesture signal includes pinch-out signals. The screen adjustment module 1200 may further function to reduce the size of content displayed in the first display screen based on the movement distances of the first touch 3100-1 and the second touch 3100-2.

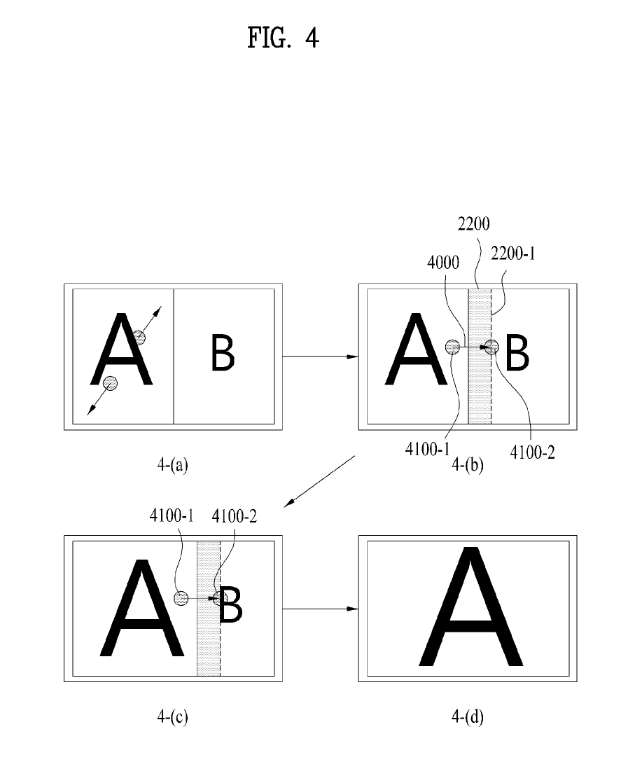

FIG. 4 is a view illustrating expansion in the size of the first display screen or screen change from the first display screen to the entire display screen in response to a multi-touch gesture signal for expansion or screen change according to an embodiment of the present disclosure.

As described above in relation to FIG. 3, the dual display apparatus according to the embodiment of the present disclosure enables expansion or reduction in the size of content displayed in any one display screen of the dual display screen in response to a multi-touch gesture signal. In this case, it may be necessary to expand the size of the corresponding display screen, or to change the corresponding display screen to the entire display screen.

As described above, conventional dual display systems may disadvantageously deteriorate user convenience because change from the corresponding display screen to the entire display screen requires a separate change function rather than being carried out by input of a multi-touch gesture signal. Accordingly, the present disclosure proposes a method of expanding the size of the corresponding display screen or changing the corresponding display screen to the entire display screen in response to a multi-touch gesture signal for expansion or screen change. In addition, for convenience, the following description is given under the assumption that the corresponding display screen is the first display screen.

FIG. 4-(a) illustrates the case in which only the size of content displayed in the first display screen is expanded by input of the pinch-in signals as illustrated in FIG. 3-(a). Then, a multi-touch gesture signal 4000 may be input to expand the size of the first display screen, or to change the first display screen to the entire display screen. The multi-touch gesture signal 4000 for expansion or screen change may include a start touch 4100-1 and an end touch 4100-2. The multi-touch gesture signal 4000 for expansion or screen change may be input by a leftward sliding touch starting from the start touch 4100-1 to the end touch 4100-2 across the imaginary boundary line 2200.

In this case, the start touch 4100-1 may be located within the first display screen, or may be located at the imaginary boundary line 2200. The end touch 4100-2 may be located within the second display screen, or may be located at an edge of the second display screen.

Assuming the case in which the multi-touch gesture signal 4000 for expansion or screen change is input by a leftward sliding touch and that the start touch 4100-1 is located in the second display screen or at the imaginary boundary line 2200 and the end touch 4100-2 is located in the first display screen or at an edge of the first display screen, the screen adjustment module 1100 according to the embodiment of the present disclosure may expand the size of the second display screen or may perform change from the second display screen to the entire display screen.

Additionally, the multi-touch gesture signal 4000 for expansion or screen change may be input in succession after the multi-touch gesture signal for expansion or reduction in the size of content displayed in the dual display screen as described above with reference to FIG. 3, and may be connected to the multi-touch gesture signal of FIG. 3 via a touch. More specifically, in the case in which the multi-touch gesture signal as described with reference to FIG. 3 includes the pinch-in signals 3000-1 and 3000-2, any one touch of the first touch 3000-1 or the second touch 3000-2 may be continuously input so as to be input as the start touch 4100-1 of the multi-touch gesture signal 4000 of FIG. 4.

The multi-touch gesture signal 4000 of FIG. 4 may be classified into a multi-touch gesture signal to expand the size of the first display screen and a multi-touch gesture signal to change the first display screen to the entire display screen, based on a sliding distance of a touch starting from the start touch 4100-1 to the end touch 4100-2.

In the embodiment of the present disclosure, the sliding distance is preset in the screen adjustment module 1100. Thus, if the sliding distance from the start touch 4100-1 to the end touch 4100-2 exceeds the preset sliding distance, the screen adjustment module 1100 may change the first display screen to the entire display screen.

On the other hand, if the sliding distance from the start touch 4100-1 to the end touch 4100-2 is less than the preset sliding distance, the screen adjustment module 1100 may expand the size of the first display screen based on the sliding distance.

FIG. 4-(b) illustrates expansion of the first display screen in the case in which the sliding distance of the multi-touch gesture signal 4000 is less than the preset sliding distance. Once the multi-touch gesture signal 4000 is input to expand the size of the first display screen, the screen adjustment module 1100 may expand the size of the first display screen by moving or deforming the imaginary boundary line 2200. More specifically, the screen adjustment module 1100 may expand the size of the first display screen by moving a position of the imaginary boundary line 2200 to a position of the end touch 4100-2 of the multi-touch gesture signal 4000, or by deforming the imaginary boundary line 2200 so as to generate a new imaginary boundary line 2200-1 at a position of the end touch 2200-1.

In this case, once the size of the first display screen is expanded, the screen adjustment module 1100 may expand the size of content displayed in the first display screen in proportion to the size of the expanded first display screen. Also, as illustrated in FIG. 4-(b), the screen adjustment module 1100 may reduce the size of the second display screen by moving or deforming the imaginary boundary line 2200. In FIG. 4-(b), a colored region represents a reduced display area of the second display screen generated as the size of the first display screen is expanded. In this case, the size of content displayed in the second display screen may be reduced in proportion to the size of the reduced second display screen, or a portion of content displayed in the second display screen corresponding to the reduced display area may not be displayed without change in the size of content.

If the sliding distance of the multi-touch gesture signal 4000 exceeds the preset sliding distance, the screen adjustment module 1100 may change the first display screen to the entire display screen illustrated in FIG. 4-(d). In this case, the screen adjustment module 1100 may expand the size of content displayed in the first display screen in proportion to the size of the entire display screen.

FIG. 4-(c) is a view illustrating the case in which the size of the first display screen, which has been expanded as illustrated in FIG. 4(b), is again expanded based on the sliding distance of the input multi-touch gesture signal 4000.

As described above, the screen adjustment module 1100 may expand the size of the first display screen based on the sliding distance of the multi-touch gesture signal 4000. Accordingly, as illustrated in FIG. 4-(c), the first display screen may be expanded by a size corresponding to the colored region. Simultaneously, the second display screen may display content in a state in which it is reduced by the corresponding region.

FIG. 4-(d) illustrates the case in which the first display screen is changed to the entire display screen. In this case, the second display screen may disappear and only the changed entire display screen may be displayed. As described above, the screen adjustment module 1100 may gradually expand the first display screen based on the sliding distance of the multi-touch gesture signal 4000, and may change the first display screen illustrated in FIG. 4-(b) or FIG. 4-(c) to the entire display screen. This may be altered according to the sequence or method, by which the user inputs the multi-touch gesture signal.

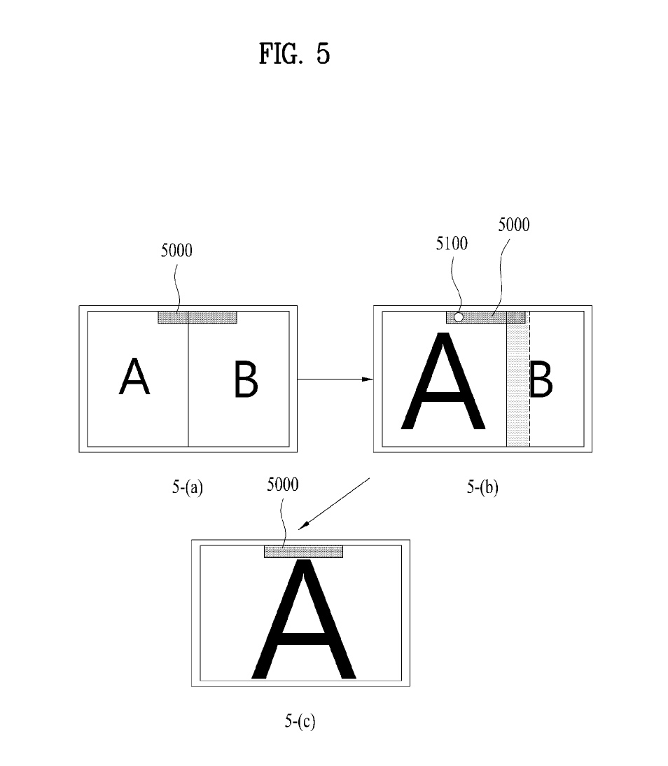

FIG. 5 is a view illustrating expansion in the size of the first display screen or change from the first display screen to the entire display screen using an indicator according to an embodiment of the present disclosure.

FIG. 5 illustrates the case in which a multi-touch gesture signal is input via the indicator according to an embodiment of the present disclosure and the size of the first display screen is expanded in response to the input multi-touch gesture signal. The indicator according to the embodiment of the present disclosure, designated by reference numeral 5000, is an area having a predetermined size, which is included in the display unit 1200 and is managed independently of the display area for display of content. The indicator 5000 may be used to receive the multi-touch gesture signal not only in the dual display apparatus, but also in a general display apparatus. Also, the indicator 5000 may have the same role as the input unit (1000, see FIG. 1), or may be used independently of the input unit. Accordingly, even if the indicator 5000 is used for input of a multi-touch gesture signal, the input unit 1000 may be simultaneous used for input of a multi-touch gesture signal.

FIG. 5-(a) is a view illustrating the indicator 5000 included in the display unit. If necessary, two indicators may be independently present in the first display screen and the second display screen respectively. In the embodiment of the present disclosure, as illustrated in FIG. 5-(a), the indicator 5000 may extend across the imaginary boundary line and be included in both the first display screen and the second display screen. This may be altered according to the intention of a designer.

FIG. 5-(b) is a view illustrating expansion of the first display screen when a multi-touch gesture signal 5100 is input via the indicator 5000. The multi-touch gesture signal 5100 input via the indicator 5000 may be input by a sliding touch.

The screen adjustment module 1100 according to the embodiment of the present disclosure may control expansion of the first display screen to a desired size based on the sliding distance and direction of the multi-touch gesture signal 5100 that is input via the indicator 5000. More specifically, the screen adjustment module 1100 according to the embodiment of the present disclosure may expand the size of the first display screen when the multi-touch gesture signal 5100 is input by a rightward sliding touch, and may expand the size of the second display screen when the multi-touch gesture signal 5100 is input by a leftward sliding touch.

Accordingly, as illustrated in FIG. 5-(b), in the case in which the multi-touch gesture signal 5100 is input by a rightward sliding touch, the screen adjustment module 1100 may select the first display screen as a target screen to be expanded, and may compare the sliding distance of the input multi-touch gesture signal 5100 with a preset sliding distance.

As described above with reference to FIG. 4, if the sliding distance of the input multi-touch gesture signal 5100 is less than the preset sliding distance, the screen adjustment module 1100 may expand the size of the first display screen based on the sliding distance. In this case, the screen adjustment module 1100 may expand the size of content displayed in the first display screen in proportion to the size of the first display screen. Also, if the sliding distance of the input multi-touch gesture signal 5100 exceeds the preset sliding distance, the screen adjustment module 1100 may change the first display screen to the entire display screen. FIG. 5-(c) is a view illustrating the case in which the first display screen is changed to the entire display screen. As described above, the screen adjustment module 1100 may gradually expand the first display screen based on the sliding distance of the multi-touch gesture signal 5100, and may directly change the first display screen illustrated in FIG. 5-(a) or FIG. 5(b) to the entire display screen.

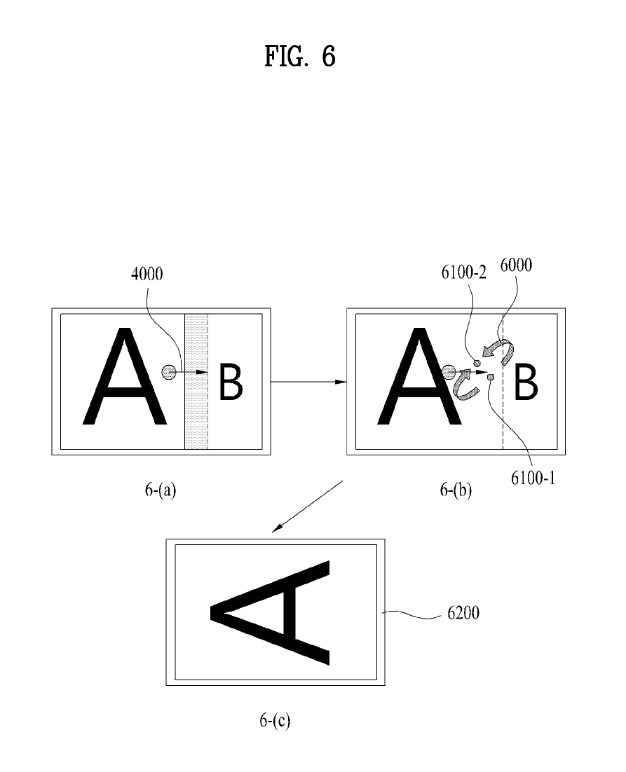

FIG. 6 is a view illustrating rotation of the first display screen in response to a multi-touch gesture signal for rotation according to an embodiment of the present disclosure.

The display unit 1200 including a touchscreen is generally configured such that a vertical length is greater than a horizontal distance for user convenience. Accordingly, as described above with reference to FIG. 4, even when the size of the first display screen is expanded or the first display screen is changed to the entire display screen, it may be necessary to rotate and display the display screen so as to suit to the size of the display unit 1200.

FIG. 6 illustrates rotation of the expanded first display screen in response to the multi-touch gesture signal for rotation, designated by reference numeral 6000.

The multi-touch gesture signal 6000 for rotation may be input to the expanded first display screen or to the entire display screen after the first display screen is changed to the entire display screen. The multi-touch gesture signal 6000 for rotation may include a start touch 6100-1 and an end touch 6100-2 that are input by a sliding touch. Also, the multi-touch gesture signal 6000 for rotation may be input in succession after the multi-touch gesture signal 4000 for expansion or reduction. More specifically, the end touch 4100-2 of the multi-touch gesture signal 4000 for expansion or reduction may be input as the start touch 6100-1 of the multi-touch gesture signal 6000 for rotation.

The multi-touch gesture signal 6000 for rotation may be input as a curvilinear continuous touch in a clockwise or counterclockwise direction starting from the start touch 6100-1 to the end touch 6100-2. Although it is unnecessary to input the curvilinear continuous touch to the expanded first display screen, the start touch 6100-1 and the end touch 6100-2 must be input to the expanded first display screen.

FIG. 6-(a) illustrates the case in which the first display screen is expanded based on the sliding distance of the multi-touch gesture signal 4000 for expansion or screen change as described above with reference to FIG. 4-(b). The multi-touch gesture signal 6000 for rotation may be input in succession after the multi-touch gesture signal 4000 for expansion or screen change.

FIG. 6-(b) illustrates the case in which the multi-touch gesture signal 6000 for rotation is input. The end touch of the multi-touch gesture signal 4000 for expansion or screen change may be input as the start touch 6100-1 of the multi-touch gesture signal 6000 for rotation. In this case, the multi-touch gesture signal 6000 for rotation may be input as a curvilinear continuous touch starting from the start touch 6100-1 to the end touch 6100-2. Also, the multi-touch gesture signal 6000 for rotation may be input in a clockwise or counterclockwise direction, and the first display screen may be changed to the entire display screen based on the input direction.

FIG. 6-(c) illustrates the case in which the multi-touch gesture signal 6000 for rotation is input in a counterclockwise direction. If the multi-touch gesture signal 6000 for rotation is input in a counterclockwise direction, the screen adjustment module 1100 according to the embodiment of the present disclosure may change the first display screen to the entire display screen 6200 such that an upper end of content is rotated leftward by 90 degrees and a lower end of content is rotated rightward by 90 degrees. In this case, the reduced second display disappears.

The above described multi-touch gesture signal 6000 for rotation may be input even after the multi-touch gesture signal 5100 for expansion or screen change is input via the indicator 5000 as described above with reference to FIG. 5. In this case, the multi-touch gesture signal 5100 for expansion or screen change, which is input via the indicator 5100, and the multi-touch gesture signal 6000 for rotation may not be input in succession. This may be altered according to the intension of a designer.

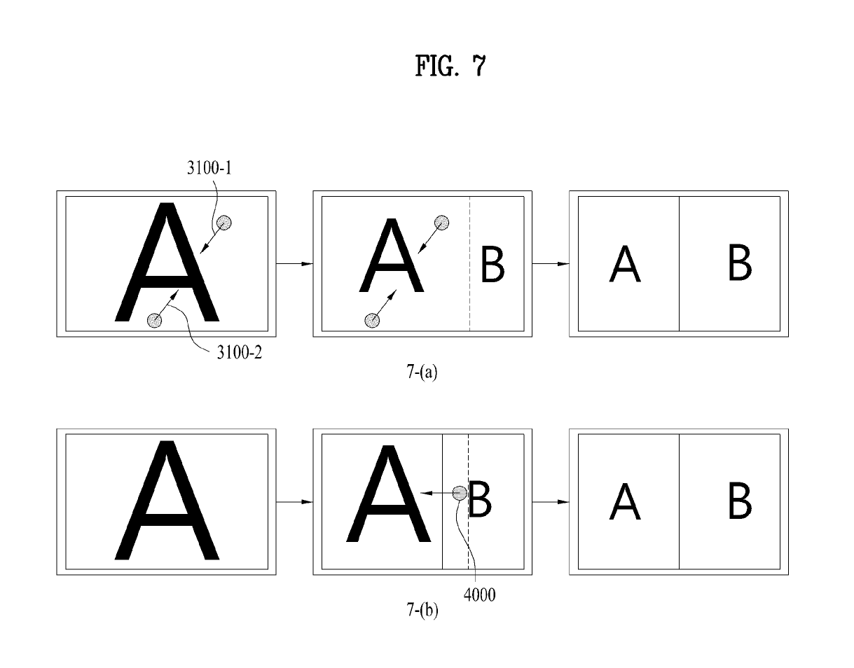

FIG. 7 is a view illustrating reduction in the size of the entire display screen in response to a multi-touch gesture signal for reduction according to an embodiment of the present disclosure.

The multi-touch gesture signal for reduction according to the embodiment of the present disclosure may include the pinch-out signals 3100-1 and 3100-2 described above with reference to FIG. 3.

FIG. 7-(a) illustrates the case in which the pinch-out signals 3100-1 and 3100-2 are used as the multi-touch gesture signal for reduction. Although the pinch-out signals 3100-1 and 3100-2 may be used as the multi-touch gesture signal to reduce the size of content displayed in the first display screen as described above, the pinch-out signals 3100-1 and 3100-2 may be used not only to reduce the size of content displayed in the entire display screen, but also to reduce the size of the entire display screen when input to the entire display screen.

As described above, the pinch-out signals 3100-1 and 3100-2 may include two touches 3100-1 and 3100-2 that are input at the same time. The screen adjustment module 1100 according to the embodiment of the present disclosure may reduce the size of the entire display screen based on the inward movement distance of each of the simultaneously input two touches.

As illustrated in the center of FIG. 7-(a), if the size of the entire display screen is reduced, the second display screen having the same size as a reduced area may be displayed. In this case, the screen adjustment module 1100 according to the embodiment of the present disclosure may reduce the size of displayed content in proportion to the reduced size of the entire display screen.

Then, once the size of the entire display screen becomes less than a preset size by the pinch-out signals 3100-1 and 3100-2, the screen adjustment module 1100 according to the embodiment of the present disclosure may change the entire display screen to a dual display screen as illustrated in the right side of FIG. 7-(a). The dual display screen may include the first display screen and the second display screen, which have the same size and are separated from each other by the imaginary boundary line.

FIG. 7-(b) illustrates reduction in the size of the entire display screen in response to the multi-touch gesture signal 4000 for reduction according to another embodiment of the present disclosure. An operation caused by the multi-touch gesture signal 4000 for reduction as illustrated in FIG. 7-(b) is an inverse operation of that caused by the multi-touch gesture signal 4000 for expansion or screen change as illustrated in FIG. 4. Although not illustrated in FIG. 7-(b), the multi-touch gesture signal 4000 for reduction may include a start touch and an end touch in the same manner as the multi-touch gesture signal 4000 for expansion or screen change.

As illustrated in the left side of FIG. 7-(b), the multi-touch gesture signal 4000 for reduction may be input by a leftward sliding touch starting from the start touch to the end touch. The screen adjustment module 1100 according to the embodiment of the present disclosure may set a new imaginary boundary line at a position of the end touch of the multi-touch gesture signal 4000 for reduction, so as to reduce the size of the entire display screen.

In this case, the screen adjustment module 1100 according to the embodiment of the present disclosure may change the entire display screen to the first display screen, which has the same size as the reduced entire display screen, and the second display screen which has the same size as a reduced area. Also, the screen adjustment module 1100 may simultaneously reduce the size of displayed content as the size of the entire display screen is reduced.

The center of FIG. 7(b) illustrates the first display screen, which has the same size as the reduced entire display screen, and the second display screen which has the same size as a reduced area. In this case, if the multi-touch gesture signal for reduction is again input, the screen adjustment module 1100 may again generate a new imaginary boundary line at a position of the end touch of the multi-touch gesture signal for reduction, thereby reducing the size of the first display screen. In this case, the size of the first display screen is reduced and the size of the second display screen is expanded by a colored display area.

As illustrated in the right side of FIG. 7-(b), when the position of the end touch of the multi-touch gesture signal 4000 for reduction becomes equal to a position of the existing imaginary boundary line, reduction in the size of the first display screen ends, and the original dual display screen may be displayed. In this case, the screen adjustment module 1100 according to the embodiment of the present disclosure may reduce the size of content displayed in the first display screen to an original size thereof.

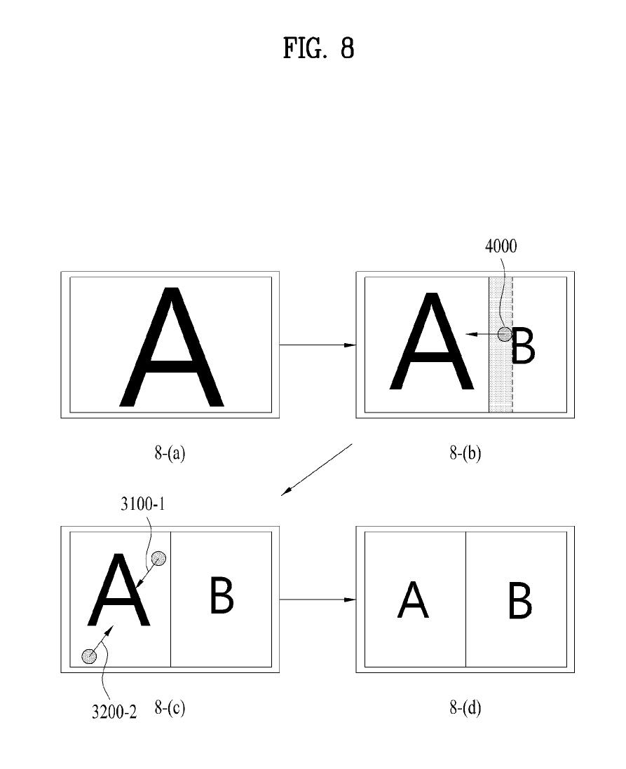

FIG. 8 is a view illustrating reduction in the size of the entire display screen in response to a multi-touch gesture signal for reduction according to another embodiment of the present disclosure.

The multi-touch gesture signal for reduction illustrated in FIG. 8 corresponds to a sequential input of the multi-touch gesture signal 4000 for reduction as described above with reference to FIG. 7-(b) and the pinch-out signals 3100-1 and 3100-2 as described above with reference to FIG. 3-(b).

FIG. 8-(a) is a view illustrating the case in which the multi-touch gesture signal 4000 for reduction is input to the entire display screen by a leftward sliding touch starting from the start touch to the end touch. The screen adjustment module 1100 according to the embodiment of the present disclosure may reduce the size of the entire display screen by setting a new imaginary boundary line at a position of the end touch of the multi-touch gesture signal 4000 for reduction. The new imaginary boundary line is represented as a solid line in FIG. 8. In this case, the screen adjustment module 1100 according to the embodiment of the present disclosure may change the entire display screen to the first display screen, which has the same size as the reduced entire display screen, and the second display screen which has the same size as a reduced area. Also, the screen adjustment module 1100 may also reduce the size of displayed content as the size of the entire display screen is reduced.

FIG. 8-(b) illustrates the first display screen, which has the same size as the reduced entire display screen, and the second display screen which has the same size as a reduced area of the entire display screen. In this case, if the multi-touch gesture signal 4000 for reduction is again input, the screen adjustment module 1100 may reduce the size of the first display screen by generating a new imaginary boundary line at a position of the end touch of the multi-touch gesture signal 4000 for reduction. In this case, the size of the first display screen is reduced and the size of the second display screen is expanded by a colored display area.

FIG. 8-(c) illustrates the case in which the position of the end touch of the multi-touch gesture signal 4000 for reduction is equal to the position of the existing imaginary boundary line. Thus, reduction in the size of the first display screen ends and an original dual display screen is displayed. In this case, if the size of content displayed in the first display screen has been expanded before the first display screen is changed to the entire display screen, the screen adjustment module 1100 according to the embodiment of the present disclosure may reduce only the size of the first display screen to the size of the original first display screen while maintaining the expanded size of the displayed content. Accordingly, the pinch-out signals 3100-1 and 3100-2 may then be input to reduce the size of content in the first display screen to the size of original content.

FIG. 8-(d) illustrates the original dual display screen in the case in which the size of content displayed in the first display screen is reduced by the pinch-out signals 3100-1 and 3100-2.

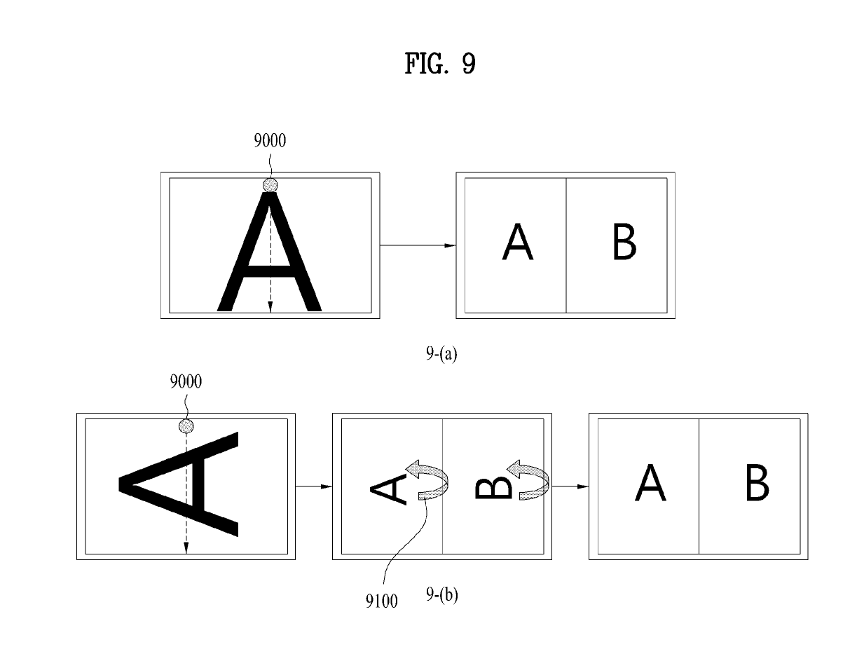

FIG. 9 is a view illustrating reduction in the size of the entire display screen in response to a multi-touch gesture signal for reduction according to another embodiment of the present disclosure.

The multi-touch gesture signal 9000 for reduction according to another embodiment of the present disclosure as illustrated in FIG. 9 may be input from an upper end to a lower end or from a lower end to an upper end of the entire display screen. Also, although not illustrated in the drawing, the multi-touch gesture signal 9000 for reduction may include a start touch and an end touch, and may be input by a downward or upward sliding touch starting from the start touch to the end touch.

FIG. 9-(a) illustrates the case in which the multi-touch gesture signal 9000 for reduction is input to the entire display screen. If the multi-touch gesture signal 9000 for reduction is input, the screen adjustment module 1100 according to the embodiment of the present disclosure may change the entire display screen to an original dual display screen.

FIG. 9-(b) illustrates the case in which the multi-touch gesture signal 9000 for reduction is input in a state in which the entire display screen is rotated as described above with reference to FIG. 6. As illustrated in the right side and the center of FIG. 9-(b), if the multi-touch gesture signal 9000 for reduction is input, the screen adjustment module 1100 according to the embodiment of the present disclosure may change the entire display screen to the dual display screen. However, since the entire display screen has been rotated, content displayed in the first display screen and content displayed in the second display screen may be displayed in a rotated state thereof. In this case, a multi-touch gesture signal 9100 for rotation (re-orientation) of content may be input. The multi-touch gesture signal 9100 for rotation (re-orientation) of content includes a start touch and an end touch, in the same manner as the multi-touch gesture signal for rotation as described above with reference to FIG. 6, and may be input by a curvilinear continuous touch starting from the start touch to the end touch. Also, the multi-touch gesture signal 9100 for rotation (re-orientation) of content may be input in a clockwise or counterclockwise direction. As illustrated in the right side of FIG. 9-(b), if the multi-touch gesture signal 9100 for rotation (re-orientation) of content is input, the screen adjustment module 1100 may rotate the content.

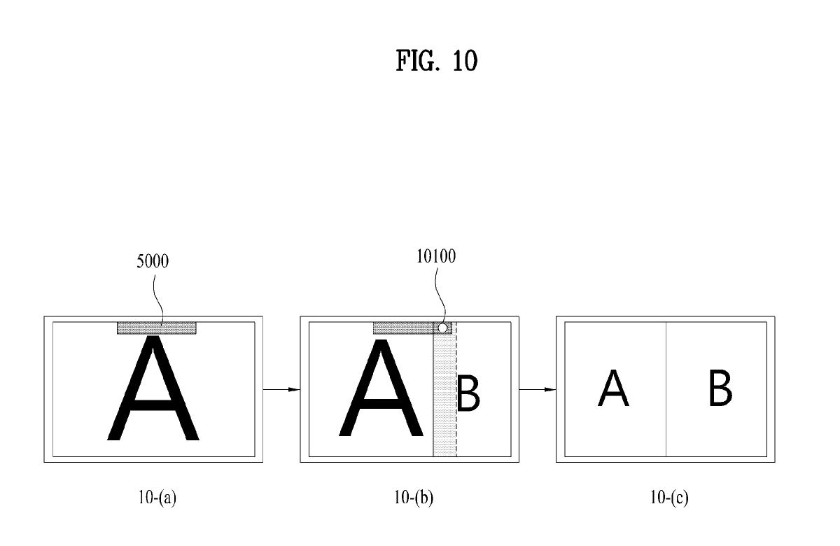

FIG. 10 is a view illustrating reduction in the size of the entire display screen in response to a multi-touch gesture signal for reduction according to a further embodiment of the present disclosure.

Referring to FIG. 10, a multi-touch gesture signal is input via the indicator 5000 as described above with reference to FIG. 5, such that the size of the entire display screen is reduced, and simultaneously the entire display screen is changed to a dual display screen in response to the input multi-touch gesture signal. This corresponds to an inverse operation of that of FIG. 5, and thus a detailed description thereof will be omitted.

FIG. 10-(a) illustrates the case in which the first display screen is changed to the entire display screen in response to the multi-touch gesture signal input via the indicator 5000 as described above with reference to FIG. 5-(c).

FIG. 10-(b) illustrates the case in which a multi-touch gesture signal 10100 for reduction is input to the entire display screen by a sliding touch using the indicator 5000. The screen adjustment module 1100 according to the embodiment of the present disclosure may control reduction of the entire display screen to a desired size based on the sliding distance and direction of the multi-touch gesture signal 10100 input via the indicator 5000. If the multi-touch gesture signal to expand the size of the first display screen is input by a rightward sliding touch using the indicator 5000 as described above with reference to FIG. 5, the multi-touch gesture signal 10100 for reduction may be input by a leftward sliding touch using the indicator 5000. The opposite case is also possible.

The screen adjustment module 1100 according to the embodiment of the present disclosure may change the entire display screen to the first display screen, which has the same size as the reduced entire display screen, and the second display screen which has the same size as a reduced area, based on the multi-touch gesture signal 10100 input via the indicator 5000. Also, the screen adjustment module 1100 may also reduce the size of displayed content as the size of the entire display screen is reduced.

Additionally, as described above with reference to FIG. 5, the screen adjustment module 1100 may gradually reduce the size of the entire display screen and may directly change the entire display screen to the dual display screen illustrated in FIG. 10-(c) based on a sliding distance of the multi-touch gesture signal 10100.

FIG. 10(c) illustrates the case in which the entire display screen is changed to the original dual display screen.

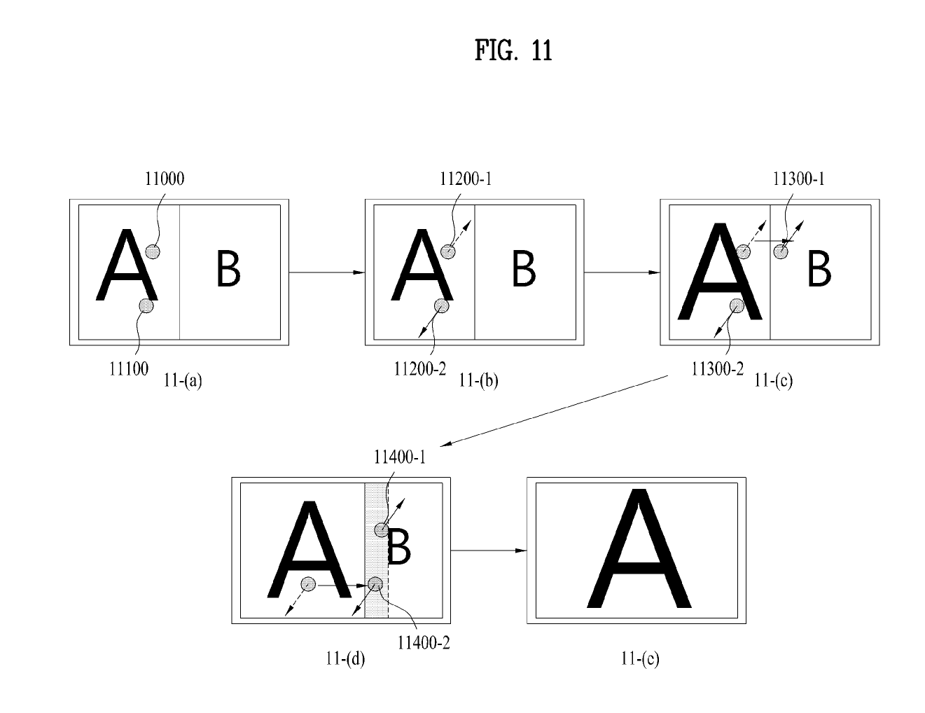

FIG. 11 is a view illustrating expansion in the size of the first display screen or change from the first display screen to the entire display screen in response to a multi-touch gesture signal for expansion or screen change according to another embodiment of the present disclosure.

FIG. 11-(a) illustrates the case in which a first touch gesture signal 11000 and a second touch gesture signal 11100 are input to the first display screen according to an embodiment of the present disclosure. The first touch gesture signal 11000 and the second touch gesture signal 11100 refer to signals input when touching a surface of the input unit 1000. The first touch gesture signal 11000 and the second touch gesture signal 11100 may be input at the same time, or may be input in sequence.

FIG. 11-(b) illustrates input of a first multi-touch gesture signal 11200-1 and 11200-2 to the first display screen according to an embodiment of the present disclosure. The first multi-touch gesture signal 11200-1 and 11200-2 may include the first touch gesture signal 11000 and the second touch gesture signal 11100. That is, two touches of the first multi-touch gesture signal 11200-1 and 11200-2 illustrated in FIG. 11-(b) are equal to the first touch gesture signal 11000 and the second touch gesture signal 11100.

The first multi-touch gesture signal 11200-1 and 11200-2 is a multi-touch gesture signal to expand or reduce the size of content displayed in the first display screen and is input by sliding gesture. Accordingly, the first multi-touch gesture signal 11200-1 and 11200-2 may be equal to the pinch-in signals 3000-1 and 3000-2 or the pinch-out signals 3100-1 and 3100-2 described above with reference to FIG. 3. The screen adjustment module 1100 according to the embodiment of the present disclosure may expand or reduce the size of content displayed in the first display screen in response to the first multi-touch gesture signal 11200-1 and 11200-2.

FIG. 11-(c) illustrates input of a second multi-touch gesture signal 11300-1 and 11300-2 according to an embodiment of the present disclosure. The second multi-touch gesture signal 11300-1 and 11300-2 is a multi-touch gesture signal to expand or reduce the size of content displayed in the first display screen and is input by sliding gesture. The second multi-touch gesture signal 11300-1 and 11300-2 may be input in succession after the first multi-touch gesture signal 11200-1 and 11200-2, and may include two touches 11300-1 and 11300-2 in the same manner as the first multi-touch gesture signal 11200-1 and 11200-2. In this case, one touch 11300-2 of the second multi-touch gesture signal 11300-1 and 11300-2 is located in the first display screen and the other one touch 11300-1 is moved to the second display screen by passing over an imaginary boundary line. More specifically, as illustrated in FIG. 11-(c), the second multi-touch gesture signal 11300-1 and 11300-2 may be input by sliding one touch 11200-1 of the first multi-touch gesture signal 11200-1 and 11200-2 across the imaginary boundary line. In this case, the moved touch 11300-1 may be located in the second display screen, and the other touch 11300-2 that is not moved may be located in the first display screen.

FIG. 11-(d) illustrates input of a third multi-touch gesture signal 11400-1 and 11400-2 according to an embodiment of the present disclosure. The third multi-touch gesture signal 11400-1 and 11400-2 is a multi-touch gesture signal to expand the size of the first display screen or to change the first display screen to the entire display screen and is input by sliding gesture. The third multi-touch gesture signal 11400-1 and 11400-2 may be input in succession after the second multi-touch gesture signal 11300-1 and 11300-2, and may include two touches 11400-1 and 11400-2 in the same manner as the first multi-touch gesture signal 11200-1 and 11200-2 and the second multi-touch gesture signal 11300-1 and 11300-2. In this case, both the two touches 11400-1 and 11400-2 of the third multi-touch gesture signal 11400-1 and 11400-2 are located in the second display screen.

More specifically, as illustrated in FIG. 11-(d), the third multi-touch gesture signal 11400-1 and 11400-2 may be input by sliding the touch 11300-2 located in the first display screen of the second multi-touch gesture signal 11300-1 and 11300-2 across an imaginary boundary line. In this case, the moved touch 11400-2 may be located in the second display screen. Also, two touches 11400-1 and 11400-2 of the third multi-touch gesture signal 11400-1 and 11400-2 may be input by a sliding touch after being located in the second display screen.

As described above with reference to FIG. 4, a preset sliding distance is set in the screen adjustment module 1100 according to the present disclosure. Accordingly, the screen adjustment module 1100 according to the embodiment of the present disclosure may expand the size of the first display screen or to change the first display screen to the entire display screen based on a sliding distance of the moved touch 11400-2 or based on a sliding distance of the two touches 11400-1 and 11400-2 which are simultaneously moved after being located in the second display screen. More specifically, if the sliding distance of the moved touch 11400-2 or the sliding distance of the two touches 11400-1 and 11400-2 which are simultaneously moved after being located in the second display screen is less than the preset sliding distance, the screen adjustment module 1100 may expand the size of the first display screen based on the sliding distance. That is, the screen adjustment module 1100 may generate a new imaginary boundary line at a position of the moved touch 11400-2 or the two touches 11400-1 and 11400-2 after completion of sliding gesture, thereby expanding the size of the first display screen.

If the sliding distance of the moved touch 11400-2 or the sliding distance of the two touches 11400-1 and 11400-2 which are simultaneously moved after being located in the second display screen exceeds the preset sliding distance, the screen adjustment module 1100 may change the first display screen to the entire display screen. In this case, the screen adjustment module 1100 may expand the size of content shown in the display screen in proportion to the size of the entire display screen.

FIG. 11-(e) illustrates the case in which the first display screen is changed to the entire display screen. In this case, the second display screen may disappear and only the entire display screen may be displayed. As described above, the screen adjustment module 1100 may gradually expand the first display screen based on the sliding distance of the third multi-touch gesture signal 11400-1 and 11400-2, and may change the first display screen to the entire display screen. This may be altered according to the sequence or method, by which the user inputs the multi-touch gesture signal.

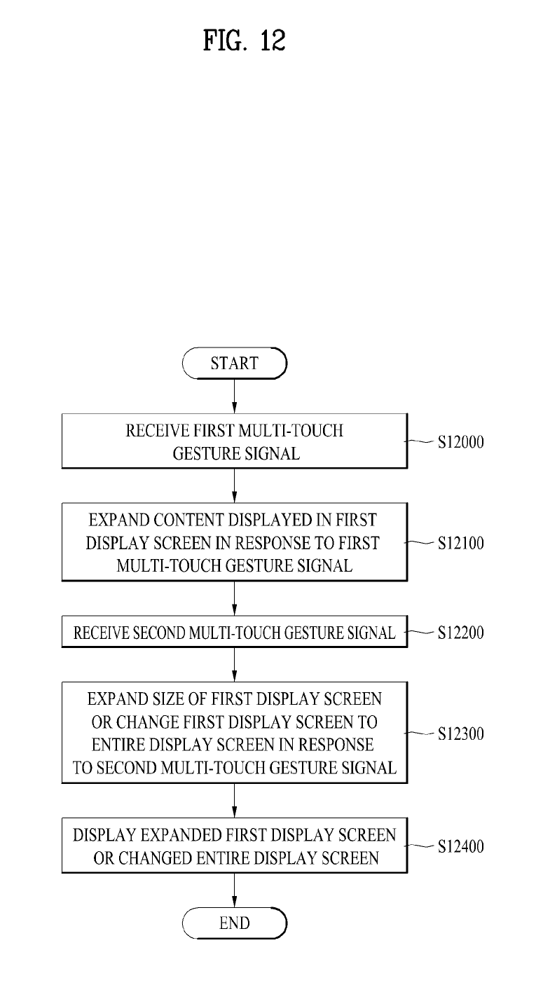

FIG. 12 is a flowchart of a dual display method according to an embodiment of the present disclosure.

The input unit 1000 according to the embodiment of the present disclosure may receive a first multi-touch gesture signal (S12000). The input unit 1000 may be included in the display unit 1200 and serve to receive the multi-touch gesture signal. In this case, the input unit 1000 may be included independently of the display area of the display unit 1200, or may be distributed in the display area. This may be altered according to the intention of a designer.

The first multi-touch gesture signal is a multi-touch gesture signal to expand the size of content displayed in the first display screen, and may include the pinch-in signals 3000-1 and 3000-2 as described above with reference to FIG. 3. The first multi-touch gesture signal may be input via two touches. The two touches may be simultaneously input only to the first display screen, or only one touch of the simultaneously input two touches may be moved to the second display screen across the imaginary boundary line.

The screen adjustment module 1100 according to the embodiment of the present disclosure may expand the size of content displayed in the first display screen in response to the first multi-touch gesture signal (S12100). The screen adjustment module 1100 serves to sense and analyze the input multi-tough gesture signal. The screen adjustment module 1100 may adjust or control the size of content displayed on the display unit 1200 or the size of each display screen included in the display unit 1200 in response to the multi-touch gesture signal. In this case, the screen adjustment module 1100 may expand the size of content based on movement distances of the two touches of the first multi-touch gesture signal.

Thereafter, the screen adjustment module 1100 according to the embodiment of the present disclosure may receive a second multi-touch gesture signal (S12200). The second multi-touch gesture signal according to the embodiment of the present disclosure is a multi-touch gesture signal to expand the size of the first display screen, or to change the first display screen to the entire display screen. The second multi-touch gesture signal may be input by a sliding touch as described above with reference to FIG. 4. The second multi-touch gesture signal may include a start touch and an end touch, which may be input by a rightward sliding touch starting from the start touch to the end touch across the imaginary boundary line.

In this case, the start touch may be located in the first display screen, and may be located at the imaginary boundary line. The end touch may be located in the second display screen and may be located at an edge of the second display screen. Also, the second multi-touch gesture signal may be input in succession after the first multi-touch gesture signal by a touch. More specifically, any one touch of the two touches of the first multi-touch gesture signal may be continuously input as the start touch of the second multi-touch gesture signal.

The second multi-touch gesture signal may be input via the indicator 5000 as described above with reference to FIG. 5. A detailed description thereof is equal to the above description of FIG. 5 and thus will be omitted hereinafter.

The screen adjustment module 1100 according to the embodiment of the present disclosure may expand the size of the first display screen, or may change the first display screen to the entire display screen based on the input second multi-touch gesture signal (S12300).

As described above with reference to FIG. 4, a preset sliding distance is set in the screen adjustment module 1100 according to the embodiment of the present disclosure. Accordingly, if the sliding distance of the second multi-touch gesture signal starting from the start touch to the end touch exceeds the preset sliding distance, the screen adjustment module 1100 may change the first display screen to the entire display screen. Also, if the sliding distance of the second multi-touch gesture signal starting from the start touch to the end touch is less than the preset sliding distance, the screen adjustment module 1100 may expand the size of the first display screen based on the sliding distance. After the size of the first display screen is expanded, the screen adjustment module 1100 may also expand the size of content displayed in the first display screen in proportion to the size of the expanded first display screen. Also, the screen adjustment module 1100 may reduce the size of the second display screen in proportion to the expansion degree of the first display screen.

Thereafter, the display unit 1200 according to the embodiment of the present disclosure may display the expanded first display screen, or the entire display screen (S12400). As described above, when the size of the first display screen is expanded and the size of the second display screen is reduced, the display unit 1200 may display the expanded first display screen and the reduced second display screen at the same time. When the first display screen is changed to the entire display screen, the display unit 1200 displays only the entire display screen, and does not display the second display screen.

As is apparent from the above description, in a dual display apparatus according to the present disclosure, it is possible to change each screen of dual display screens to the entire display screen using multi-touch gesture, which may maximize user convenience.

Further, adjusting the size of each screen of dual display screens using multi-touch gesture may provide a user with various user interfaces.

It will be apparent to those skilled in the art that various modifications and variations can be made in the present disclosure without departing from the spirit or scope of the disclosure. Thus, it is intended that the present disclosure covers the modifications and variations of this disclosure provided they come within the scope of the appended claims and their equivalents.

What is claimed is:

1. A dual display method to display first and second display screens, the method comprising:
receiving a first multi-touch gesture signal, wherein the first multi-touch gesture signal includes pinch-in signals to expand the size of content displayed in the first display screen;
expanding the size of content displayed in the first display screen in response to the first multi-touch gesture signal if the input first multi-touch gesture signal includes the pinch-in signals;
receiving a second multi-touch gesture signal, wherein the second multi-touch gesture signal includes a sliding touch to expand the size of the first display screen or to change the first display screen to the entire display screen; and
displaying the expanded first display screen or the changed entire display screen in response to the input second multi-touch gesture signal,
wherein the first multi-touch gesture signal and the second multi-touch gesture signal are input in succession via a continuous touch.

2. A dual display apparatus to display first and second display screens, the apparatus comprising:
a display unit to display the first and second display screens;
an input unit to receive a first multi-touch gesture signal or a second multi-touch gesture signal, wherein first multi-touch gesture signal includes pinch-in signals to expand the size of content displayed in the first display screen, and the second multi-touch gesture signal includes a sliding touch to expand the size of the first display screen or to change the first display screen to the entire display screen; and
a screen adjustment module to expand the size of content displayed in the first display screen in response to the first multi-touch gesture signal, and to display the expanded first display screen or the changed entire display screen in response to the second multi-touch gesture signal,
wherein the first multi-touch gesture signal and the second multi-touch gesture signal are input in succession via a continuous touch.

3. The dual display apparatus according to claim 2, wherein the first and second display screens are divided from each other by an imaginary boundary line, and the imaginary boundary line is represented by any one of a dotted line, a solid line, and an area having a predetermined size.

4. The dual display apparatus according to claim 3,
wherein the first multi-touch gesture signal includes a first touch and a second touch that are input at the same time,
wherein the second multi-touch gesture signal includes a start touch and an end touch, the second multi-touch gesture signal being input by a sliding touch starting from the start touch to the end touch across the imaginary boundary line.

5. The dual display apparatus according to claim 4, wherein the screen adjustment module expands the size of the first display screen or changes the first display screen to the entire display screen by sensing the second multi-touch gesture signal based on a distance from the start touch to the end touch and a sliding input time from the start touch to the end touch, and moving a position of the imaginary boundary line to a position of the end touch or deforming the imaginary boundary line to thereby generate a new imaginary boundary line at the position of the end touch.

6. The dual display apparatus according to claim 5, wherein the screen adjustment module changes the first display screen to the entire display screen if a sliding distance of the second multi-touch gesture signal exceeds a preset distance.

7. The dual display apparatus according to claim 5, wherein the screen adjustment module expands the size of the first display screen based on the position of the end touch if a sliding distance of the second multi-touch gesture signal is less than a preset distance.

8. The dual display apparatus according to claim 7, wherein the screen adjustment module reduces the size of the second display screen based on the position of the end touch.

9. The dual display apparatus according to claim 8, wherein the display unit displays the expanded first display screen and the reduced second display screen at a time.

10. The dual display apparatus according to claim 4,
wherein the input unit receives third multi-touch gesture signal for rotation of the expanded first display screen or the changed entire display screen, the third multi-touch gesture including tapping and holding,
wherein the screen adjustment module rotates the expanded first display screen or the entire display screen in response to the third multi-touch gesture, and
the display unit displays the rotated first display screen or the entire display screen.

11. The dual display apparatus according to claim 4,
wherein the input unit receives a fourth multi-touch gesture signal to reduce the size of the expanded first display screen or to change the entire display screen to the first display screen, and
wherein the screen adjustment module reduces the size of the expanded first display screen or changes the entire display screen to the first display screen in response to the input fourth multi-touch gesture signal.

12. The dual display apparatus according to claim 11, wherein the fourth multi-touch gesture signal includes pinch-out signals and a sliding touch.

13. The dual display apparatus according to claim 12, wherein the screen adjustment module changes the entire display screen to the first display screen if the fourth multi-touch gesture signal includes the pinch-out signals or if a sliding distance of the fourth multi-touch gesture signal exceeds a preset distance.

14. The dual display apparatus according to claim 13, wherein the screen adjustment module reduces the size of the expanded first display screen by deforming a boundary line of the expanded first display screen or moving a position of the boundary line of the expanded first display screen if the sliding distance of the fourth multi-touch gesture signal is less than the preset distance.

15. The dual display apparatus according to claim 4, wherein the first and second display screens include an indicator.

16. The dual display apparatus according to claim 15, wherein the indicator receives the second multi-touch gesture signal.

17. The dual display apparatus according to claim 16,
wherein the indicator receives a fourth multi-touch gesture signal to reduce the size of the expanded first display screen or to change the entire display screen to the first display screen, and
wherein the screen adjustment module reduces the size of the expanded first display screen or changes the entire display screen to the first display screen in response to the input fourth multi-touch gesture signal.

18. A dual display method to display a first display screen that displays first content and a second display screen that displays second content, the method comprising:
receiving first and second touch gesture signals to the first display screen;
receiving a first multi-touch gesture signal to the first display screen, wherein the first multi-touch gesture signal expands or reduces the size of content displayed in the first display screen;
receiving a second multi-touch gesture signal, wherein the second multi-touch gesture signal expands or reduces the size of content displayed in the first display screen, and the second multi-touch gesture signal includes input of any one signal of the first and second touch gesture signals to the second display screen; and
receiving a third multi-touch gesture signal, wherein the third multi-touch gesture signal includes input of the first and second multi-touch gesture signals to the second display screen, and the third multi-touch gesture signal expands the size of the first display screen or changes the first display screen to the entire display screen,
wherein the first multi-touch gesture signal includes successive first and second touch gesture signals, and the first to third multi-touch gesture signals include successive sliding gesture.

19. A dual display apparatus to display a first display screen that displays first content and a second display screen that displays second content, the apparatus comprising:
an input unit to receive first and second touch gesture signals and first to third multi-touch gesture signals; and
a screen adjustment module to expand or reduce the size of content displayed in the first display screen in response to the first and second multi-touch gesture signals, and to expand the size of the first display screen or to change the first display screen to the entire display screen in response to the third multi-touch gesture signal,
wherein the first multi-touch gesture signal includes successive first and second touch gesture signals,
wherein the second multi-touch gesture signal includes input of any one signal of the first and second touch gesture signals to the second display screen,
wherein the third multi-touch gesture signal includes input of the first and second multi-touch gesture signals to the second display screen, and
wherein the first to third multi-touch gesture signals include successive sliding gesture.
